(19) United States
(12) Patent Application Publication
(10) Pub. No.: US 2014/0035721 A1
(43) Pub. Date: Feb. 6, 2014

(54) Accessing a Secure Locker Via A Mobile Device

(71) Applicant: Google Inc., Mountain View, CA (US)

(72) Inventors: Travis Jon Heppe, Alameda, CA (US); Tanvir Hassan, Alameda, CA (US)

(73) Assignee: Google Inc., Mountain View, CA (US)

(21) Appl. No.: 13/957,820

(22) Filed: Aug. 2, 2013

Related U.S. Application Data
(60) Provisional application No. 61/679,028, filed on Aug. 2, 2012.

(51) Int. Cl. G07C 9/00

(52) U.S. Cl. CPC G07C 9/00912
USPC 340/5.54

(57) ABSTRACT

System and/or method for accessing a locker are provided. In some aspects, a method may include receiving, from a server, a password for accessing a locker, where the locker meets a set of requirements. The method may also include transmitting, to a computing device associated with the locker, the password for facilitating unlocking the locker. The method may also include receiving, from the computing device associated with the locker, a first confirmation message that the locker has been unlocked. The method may also include transmitting, to the server, a second confirmation message indicating that the locker has been unlocked in response to the first confirmation message.

### RELATED APPLICATOINS

This application claims priority and the benefit under 35 U.S.C. §119(e) of U.S. provisional patent application 61/679,028, filed on Aug. 2, 2012, entitled “Accessing A Secure Locker Via A Mobile Device,” the entire contents and substance of which are hereby incorporated by reference as if fully set forth below.

### TECHNICAL FIELD

The subject technology generally relates to computer systems for interacting with mobile devices and, in particular, relates to accessing a secure locker via a mobile device.

### BACKGROUND

Oftentimes, customers purchase goods via the Internet and receive the goods at their homes by postal mail or courier. However, Internet shopping schemes suffer from various drawbacks. For example, a passerby may steal packages ordered via the Internet and left outside of a home by a courier. Also, certain goods (e.g., food) may be damaged if left outside of a home and, thus, oftentimes are not purchased over the Internet. As the foregoing illustrates, a new approach for delivering goods may be desirable.

Further limitations and disadvantages of conventional and traditional approaches will become apparent to one of skill in the art, through comparison of such approaches with some aspects of the present method and/or system set forth in the remainder of this disclosure with reference to the drawings.

### BRIEF SUMMARY

Method and/or system for accessing a secure locker via a mobile device, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

The features of the subject technology are set forth in the appended claims. However, for purpose of explanation, several aspects of the present disclosure are set forth in the following figures.

FIG. 1A illustrates an example of a passive locker system configured to implement accessing a secure locker via a mobile device.

FIG. 1B illustrates an example of an active locker system configured to implement accessing a secure locker via a mobile device.

FIG. 2 illustrates an example of the management server of FIG. 1A or FIG. 1B detail.

FIG. 3 illustrates an example of a mobile device configured to access a secure locker.

FIG. 4 illustrates an example of a locker computer for a secure locker configured to be accessed via a mobile device.

FIG. 5 illustrates an example process by which a mobile device may access a secure locker in a passive locker system.

FIG. 6 illustrates an example process by which a locker computer may allow access to a mobile device an active locker system.

FIG. 7 illustrates an example process by which a server may allow a mobile device to access a secure locker.

FIG. 8 conceptually illustrates an example electronic system with which some implementations of the subject technology are implemented.

### DETAILED DESCRIPTION

The present disclosure relates to a method and/or system for accessing a secure locker via a mobile device. In various embodiments of the disclosure, a method and/or system for accessing a secure locker via a mobile device may include receiving, from a server, a password for accessing a locker, where the locker meets a set of requirements. The method and/or system may also include transmitting, to a computing device associated with the locker, the password for facilitating unlocking the locker. The method and/or system may also include receiving, from the computing device associated with the locker, a first confirmation message that the locker has been unlocked. The method and/or system may also include transmitting, to the server, a second confirmation message indicating that the locker has been unlocked in response to the first confirmation message.

The present disclosure may relate to a non-transitory computer-readable medium. The computer-readable medium may include instructions that, when executed by a computer, cause the computer to implement a method for accessing a locker. The instructions may include code for receiving a password for accessing a locker, where the locker meets a set of requirements. The instructions may also include code for transmitting, via a short-range radio connection, the password for facilitating unlocking the locker. The instructions may also include code for receiving, via the short-range radio connection, a first confirmation message that the locker has been unlocked. The instructions may also include code for transmitting a second confirmation message indicating that the locker has been unlocked in response to the first confirmation message.

The present disclosure may relate to a mobile device. The mobile device may include a radio for short-range communication. The mobile device may also include a radio for long-range communication. The mobile device may also include one or more processors. The mobile device may also include a memory. The memory may include instructions which, when executed by the one or more processors, cause the one or more processors to implement a method for accessing a locker. The instructions may include code for receiving, from a server, via the radio for long-range communication, a password for accessing a locker, where the locker meets a set of requirements. The instructions may also include code for transmitting, to a computing device associated with the locker, via the radio for short-range communication, the password for facilitating unlocking the locker. The instructions may also include code for receiving, from the computing device associated with the locker, via the radio for short-range communication, a first confirmation message that the locker has been unlocked. The instructions may also include code for transmitting, to the server, via the radio for long-range communication, a second confirmation message indicating that the locker has been unlocked in response to the first confirmation message.

The present disclosure may relate to a computer-implemented method for managing a locker. The method may include receiving, from a mobile device, via a short-range radio connection, a request to unlock a locker, the request including a password. The method may also include verifying the password. The method may also include facilitating unlocking the locker in response to verifying the password. The method may also include receiving an indication that the locker has been closed. The method may also include transmitting, to a server, one or more messages indicating that the locker has been unlocked and closed. The one or more messages may be for updating a data structure, on the server, indicating whether the locker is occupied.

The present disclosure may relate to a non-transitory computer-readable medium. The computer-readable medium may include instructions that, when executed by a computer, cause the computer to implement a method for managing a locker. The instructions may include code for receiving, from a mobile device, via a short-range radio connection, a request to unlock a locker, the request including a password. The instructions may also include code for verifying the password. The instructions may also include code for facilitating unlocking the locker in response to verifying the password. The instructions may also include code for updating a local data structure indicating whether the locker is occupied based on the indication that the locker has been unlocked. The instructions may also include code for transmitting, to a server, one or more messages indicating that the locker has been unlocked. The one or more messages may be for updating a data structure, on the server, indicating whether the locker is occupied.

The present disclosure may relate to a computing device. The computing device may include one or more processors. The computing device may also include a near field communication radio. The computing device may also include a network interface. The computing device may also include a memory. The memory may include instructions which, when executed by the one or more processors, cause the one or more processors to implement a method for managing a locker. The instructions may include code for receiving, from a mobile device, via the near field communication radio, a request to unlock a locker, the request including a password. The instructions may also include code for verifying the password. The instructions may also include code for facilitate unlocking the locker in response to verifying the password. The instructions may also include code for transmitting, via the network interface, to a server, one or more messages indicating that the locker has been unlocked. The one or more messages may be for updating a data structure, on the server, indicating whether the locker is occupied.

The present disclosure may relate to a non-transitory computer-readable medium. The computer-readable medium may include instructions that, when executed by one or more computers, cause the one or more computers to implement a method for managing a set of lockers. The instructions may include code for determining a specific locker, where the specific locker meets a set of requirements. The instructions may also include code for providing an indication of the specific locker to a messaging system. The instructions may also include code for providing a password for unlocking the specific locker to a mobile device. The instructions may also include code for receiving a confirmation message indicating that the specific locker has been unlocked. The instructions may also include code for updating a data structure indicating whether the specific locker is occupied in response to receiving the confirmation message.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “block” refers to functions, processes, threads, etc. than can be performed by one or more circuits. As utilized herein, the term “e.g.,” introduces a list of one or more non-limiting examples, instances, or illustrations. As utilized herein, the term “server” may refer to a plurality of machines, at least some of which may be installed in different locations, and each of which may be utilized to implement distinct and/or redundant functions associated with operations attributed to and/or performed by the server.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is generally directed to an approach for delivering goods to an end-recipient. More specifically, the subject technology involves a courier placing the end-recipient's goods in a secure locker and the end-recipient accessing his/her goods in the locker using a mobile device. The secure locker may be located in a room or other space (e.g., on a street corner or outside a drug store) with one or more secure lockers. The secure locker may be a locker for a single person or a small group of people located outside of a home or a set of lockers for multiple different people located in a public place (e.g., at a post office or a shipping store). In one example, each of the secure lockers may be associated with one or more requirements (e.g., size, shape, refrigeration, geographic location, etc.).

A first example implementation of the subject technology may relate to a mobile device accessing a passive locker computer. The mobile device may receive, from a server, a password for accessing a locker. The locker may meet a set of requirement (e.g., the locker contains a package for the user of the mobile device or a package is to be placed in the locker and the locker meets the size, shape, refrigeration, or geographic location requirements for receiving the package). For example, the mobile device may belong to an end-recipient of a package, e.g., a customer of an online store, or to a courier who places packages in lockers for end-recipients. The mobile device may transmit, via a near field communication (NFC) connection, to a computing device (e.g., a NFC reader) associated with the locker, the password for facilitating unlocking the locker. The mobile device may receive, via the NFC connection, from the computing device associated with the locker, a first confirmation message that the locker has been unlocked. The mobile device may transmit, to the server, a second confirmation message indicating that the locker has been unlocked in response to the confirmation message. In response, the server may update a data structure on the server representing the occupied/unoccupied state of the locker. For example, if the locker was previously occupied and the user of the mobile device removed a package from the locker, the server may update the data structure to indicate that the locker is unoccupied. If the locker was previously unoccupied, and the user of the mobile device placed a package in the locker, the server may update the data structure to indicate that the locker is occupied.

A second example implementation of the subject technology may relate to an active locker computer allowing a mobile device having appropriate permissions to unlock a locker. The active locker computer may receive, from a mobile device, via a NFC connection, a request to unlock a locker. The request includes a password. The active locker computer may verify the password. The active locker computer may facilitate unlocking the locker in response to verifying the password. For example, the active locker computer may transmit, to the locker, instructions to unlock. The active locker computer may receive an indication (e.g., via a sensor on the locker) that the locker has been closed. The active locker computer may update a local data structure, residing on the active locker computer, that indicates whether the locker is occupied based on the indication that the locker has been unlocked and closed. The active locker computer may also transmit, to a server, a message indicating that the locker has been unlocked and closed. The message may be for updating a data structure, on the server, indicating whether the locker is occupied.

As used herein, the term “passive” may encompass its plain and ordinary meaning including but not limited to a system or device that lacks a network connection (e.g., an Internet connection or a cellular network connection). The term “active” may encompass its plain and ordinary meaning including but not limited to a system or device that has a network connection (e.g., an Internet connection or a cellular network connection.

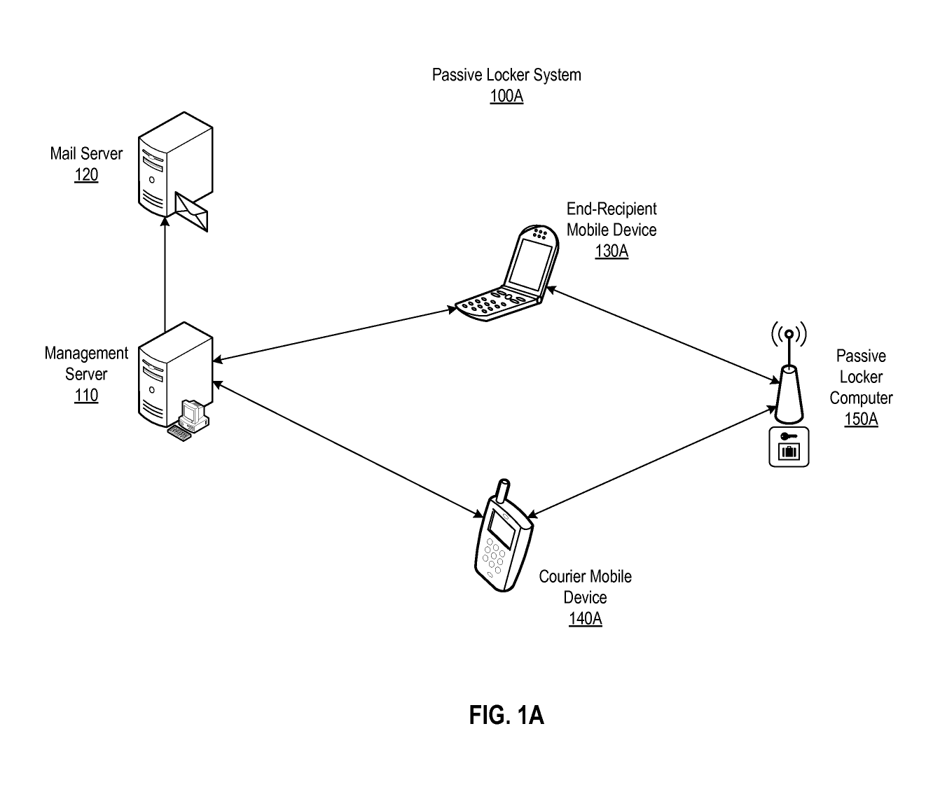

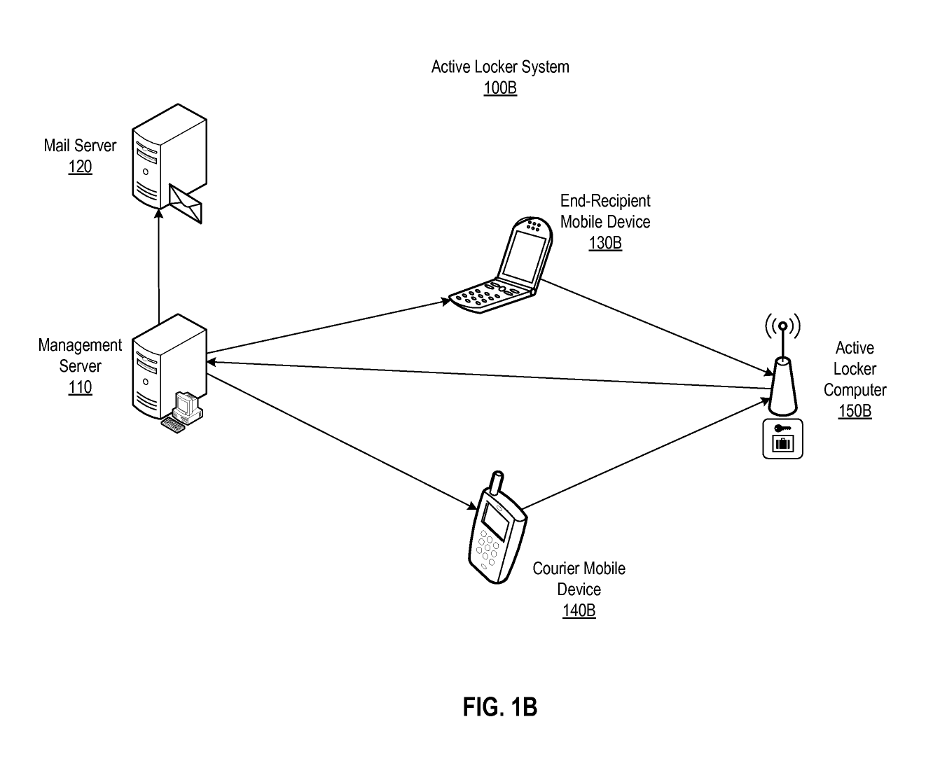

FIG. 1A illustrates an example of a passive locker system 100A configured to implement accessing a secure locker via a mobile device. As shown, the passive locker system 100A may include a management server 110, a mail server 120, an end-recipient mobile device 130A, a courier mobile device 140A, and a passive locker computer 150A.

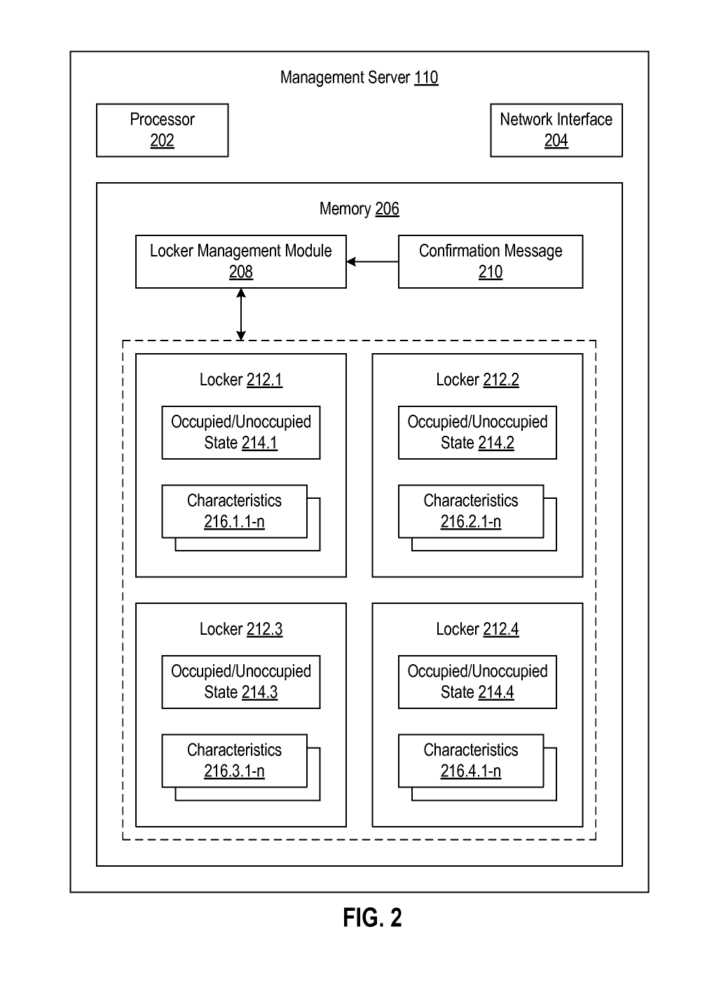

The management server 110 may comprise suitable logic, circuitry, interfaces, and/or code that may be operable to manage one or more lockers. The management server 110 may be implemented as a single machine with a single processor, a multiprocessor machine, or as multiple machines with multiple processors. The management server 110 may include, in its memory a data structure including representations of the lockers, whether the lockers are occupied, and the characteristics (e.g., dimensions, refrigeration, geographic location, etc.) of the lockers. The management server 110 is described in greater detail in FIG. 2 below.

The mail server 120 may comprise suitable logic, circuitry, interfaces, and/or code that may be operable to communicate with the management server 110. The mail server 120 may be implemented as a single machine with a single processor, a multiprocessor machine, or as multiple machines with multiple processors. The management server 110 may, upon receiving an indication that a package has been placed in a locker for an end-recipient, send to the mail server 120 instructions for the mail server to send an electronic message (e.g., an email message or a mobile phone text message) to the end-recipient notifying him/her that the package is available for pick up. The mail server 120 may execute the received instructions.

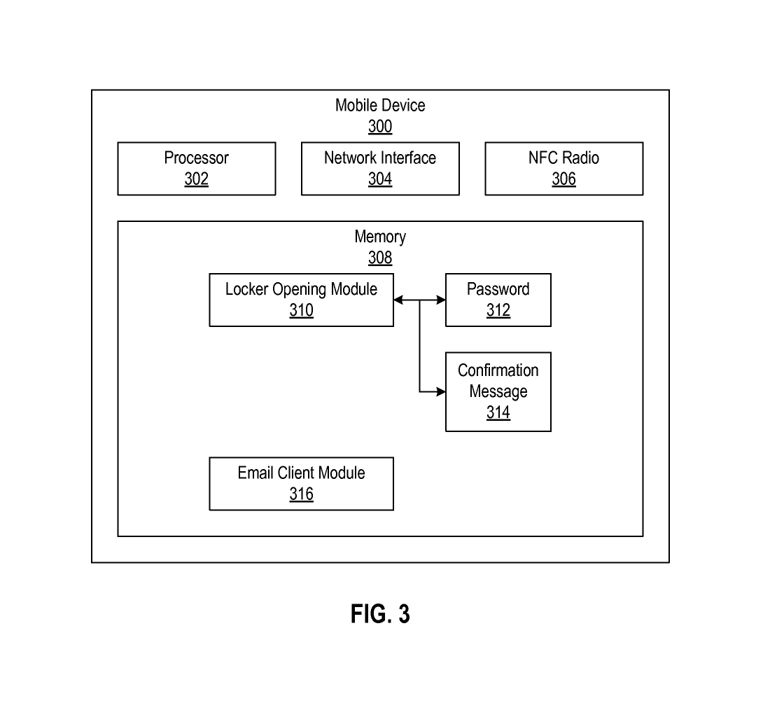

The end-recipient mobile device 130A may be any mobile device that may include one or more processors, a memory, a short-range radio (e.g., a NFC radio) and a network interface for long-range communications (e.g., a cellular network interface or a WiFi network interface). For example, the end-recipient mobile device 130A may be a mobile phone, a tablet computer, a laptop computer, a personal digital assistant (PDA), or a portable digital music player. The end-recipient mobile device 130A may comprise suitable logic, circuitry, interfaces, and/or code that may be operable to receive, from the management server 110, a password for accessing a locker containing a package for the end-recipient. The end-recipient mobile device 130A may also be configured to transmit, to the locker computer 150A, the password for unlocking the locker. The end-recipient mobile device 130A may also be configured to receive, from the locker computer 150A, a first confirmation message that the locker has been unlocked. The end-recipient mobile device 130A may transmit, to the management server 110, a second confirmation message indicating that the locker has been unlocked. A mobile device that can implement the functions of the end-recipient mobile device 130A is described in greater detail in conjunction with FIG. 3.

The courier mobile device 140A may be any mobile device that may include one or more processors, a memory, a short-range radio (e.g., a NFC radio) and a network interface for long-range communications (e.g., a cellular network interface or a WiFi network interface). For example, the courier mobile device 140A may be a mobile phone, a tablet computer, a laptop computer, a personal digital assistant (PDA), or a portable digital music player. The courier mobile device 140A may comprise suitable logic, circuitry, interfaces, and/or code that may be operable to receive, from the management server 110, a password for accessing a locker in which a package for the end-recipient is to be placed. The courier mobile device 140A may also be configured to transmit, to the locker computer 150A, the password for unlocking the locker. The courier mobile device 140A may also be configured to receive, from the locker computer 150A, a first confirmation message that the locker has been unlocked. The courier mobile device 140A may transmit, to the management server 110, a second confirmation message indicating that the locker has been unlocked. A mobile device that can implement the functions of the courier mobile device 140A is described in greater detail in conjunction with FIG. 3.

The passive locker computer 150A may be, for example, a NFC reader. The passive locker computer 150A may comprise suitable logic, circuitry, interfaces, and/or code that may be operable to receive from a mobile device (e.g., mobile device 130A or 140A) a request to unlock a locker. The request may include a password. The passive locker computer 150A may verify the password. The passive locker computer 150A may be configured to facilitate unlocking the locker in response to verifying the password and to transmit, to the mobile device, a message indicating that the locker was unlocked.

FIG. 1B illustrates an example of an active locker system 100B configured to implement accessing a secure locker via a mobile device. As shown, the passive locker system 100A may include a management server 110, a mail server 120, an end-recipient mobile device 130B, a courier mobile device 140B, and an active locker computer 150B.

The management server 110 and the mail server 120 are similar, in terms of structure and operation, to the management server 110 and the mail server 120 of FIG. 1A.

The end-recipient mobile device 130B may be any mobile device that includes one or more processors, a memory, a short-range radio (e.g., a NFC radio) and a network interface for long-range communications (e.g., a cellular network interface or a WiFi network interface). For example, the end-recipient mobile device 130B may be a mobile phone, a tablet computer, a laptop computer, a personal digital assistant (PDA), or a portable digital music player. The end-recipient mobile device 130B may comprise suitable logic, circuitry, interfaces, and/or code that may be operable to receive, from the management server 110, a password for accessing a locker containing a package for the end-recipient. The end-recipient mobile device 130B may also be configured to transmit, to the locker computer 150B, the password for unlocking the locker.

The courier mobile device 140B may be any mobile device that includes one or more processors, a memory, a short-range radio (e.g., a NFC radio) and a network interface for long-range communications (e.g., a cellular network interface or a WiFi network interface). For example, the courier mobile device 140B may be a mobile phone, a tablet computer, a laptop computer, a personal digital assistant (PDA), or a portable digital music player. The courier mobile device 140B may comprise suitable logic, circuitry, interfaces, and/or code that may be operable to receive, from the management server 110, a password for accessing a locker in which a package for the end-recipient is to be placed. The courier mobile device 140B may also be configured to transmit, to the locker computer 150B, the password for unlocking the locker.

The active locker computer 150B may be, for example, a computer that includes a NFC reader, a network interface for the Internet or a cellular network, one or more processors, and a memory. The active locker computer 150B may comprise suitable logic, circuitry, interfaces, and/or code that may be operable to receive from a mobile device (e.g., mobile device 130B or 140B) a request to unlock a locker. The request may include a password. The active locker computer 150B may verify the password. The active locker computer 150B may be configured to facilitate unlocking the locker in response to verifying the password. The active locker computer 150B may be configured to receive an indication that the locker has been closed. The active locker computer 150B may be configured to update a local data structure indicating whether the locker is occupied based on the indication that the locker has been unlocked and closed. The active locker computer 150B may be configured to transmit, to the management server 110, via the network interface, one or more messages indicating that the locker has been unlocked and closed. In response, the management server 110 may be configured to update a data structure, on the management server 110, indicating whether the locker is occupied.

FIG. 2 illustrates an example of the management server 110 of FIG. 1A or FIG. 1B detail. While the management server 110 is illustrated in FIG. 2 as a single machine, the management server 110 may be implemented as a server farm including multiple machines.

As shown, the management server 110 may include a processor 202, a network interface 204, and a memory 206. The processor 202 may comprise suitable logic, circuitry, interfaces, and/or code that may be operable to execute computer instructions that are stored in a computer-readable medium, for example, the memory 206. The processor 202 may be a central processing unit (CPU). While only one processor 202 is illustrated, the management server 110 may include multiple processors. The network interface 204 may comprise suitable logic, circuitry, interfaces, and/or code that may be operable to allow the management server 110 to transmit and receive data in a network, e.g., the Internet or a cellular network. The network interface 204 may include one or more network interface cards (NICs). The memory 206 may comprise suitable logic, circuitry, interfaces, and/or code that may be operable to store data and/or instructions. As illustrated, the memory 206 may include a locker management module 208, a confirmation message 210, and data structures representing one or more lockers 212.

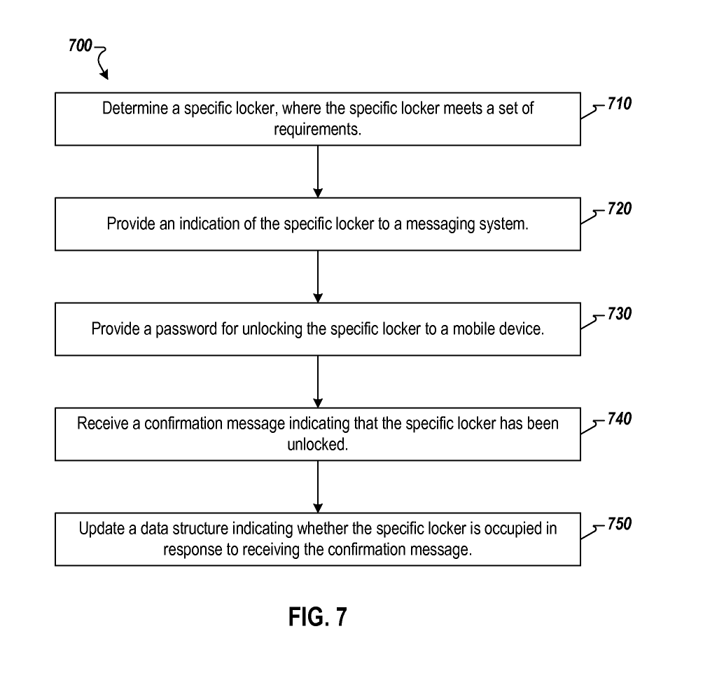

The locker management module 208 may comprise suitable logic, circuitry, interfaces, and/or code that may be operable to determine a specific locker from the data structures representing one or more lockers 212. The specific locker may meet a set of requirements. The locker management module 208 may also be configured to provide an indication of the specific locker to a messaging system (e.g., the mail server 120). The locker management module 208 may also be configured to provide a password for unlocking the locker to a mobile device (e.g., mobile device 130A, 140A, 130B, or 140B). The locker management module 208 may also be configured to receive the confirmation message 210 indicating that the specific locker has been unlocked. The locker management module 208 may also be configured to update a data structure representing one or more lockers 212 to indicate whether the specific locker is occupied in response to receiving the confirmation message 210. One example of the operation of the locker management module 208 is described in detail in conjunction with FIG. 7 below. Also, while the locker management module 208 is illustrated in FIG. 2 as a single module, the locker management module 208 may be implemented either as a single module or as multiple modules, each of which is configured to carry out one or more of the steps described above.

The confirmation message 210 may be received from an end-recipient mobile device 130A or a courier mobile device. The confirmation message 210 may include indications that one or more lockers have been unlocked or indications of an occupied/unoccupied state for the one or more lockers. The confirmation message 210 may be used to update an occupied/unoccupied state for the one or more lockers, as each time a locker is unlocked, its occupied/unoccupied state may change. In the passive locker system 100A, the confirmation message 210 may be received from the end-recipient mobile device 130A or from the courier mobile device 140A. The confirmation message 210 from the end-recipient mobile device 130A may indicate that the locker is unoccupied. The confirmation message 210 from the courier mobile device 140A may indicate that the locker is occupied. In the active locker system 100B, the confirmation message 210 may be received from the active locker computer 150B. In example aspects, the confirmation message 210 may include indications whether multiple lockers have been unlocked during a specified time period (e.g., within the last one hour, one day, one week, or one month before the confirmation message 210 was generated).

The data structure representing a locker 212.1 may correspond to a locker managed by the management server 110. The data structure representing the locker 212.1 may include an indication of an occupied/unoccupied state 214.1 of the locker (i.e., whether the locker 212.1 is occupied or unoccupied). In example aspects, the occupied/unoccupied state 214.1 may be represented as a Boolean value (True or False) or as a single-bit value (0 or 1).

The data structure representing the locker 212.1 may also include an indication of characteristics 216.1.1-n of the locker 212.1. Example characteristics 216.1.1-n may include locker geographic location, locker size, locker dimensions, locker refrigeration, locker identity verifications, hours of accessibility to the locker, distance between the locker and a parking spot, availability of identity card verification at the locker, etc. Example characteristics 216.1.1-n may also include whether the locker has been assigned to a courier for placing a package, i.e., whether a package is expected to be placed in the locker in the near future.

Other data structures representing lockers 212.2-4 may include data similar to the data structure representing the locker 212.1. Furthermore, while data structures representing four lockers 212.1-4 are illustrated in FIG. 2, the subject technology may be implemented with any number of data structures representing of lockers 212 stored on the management server 110. For example, the management server 110 may store data structures representing one locker, ten lockers, 100 lockers, 1000 lockers, or more than 1000 lockers.

FIG. 3 illustrates an example of a mobile device 300 configured to access a secure locker. The mobile device 300 may correspond to the end-recipient mobile device 130A or the courier mobile device 140A in the passive locker system 100A or to the end-recipient mobile device 130B or the courier mobile device 140B in the active locker system 100B.

As shown, the mobile device 300 may include a processor 302, a network interface 304, a near field communication (NFC) radio 306, and a memory 308. The processor 302 may comprise suitable logic, circuitry, interfaces, and/or code that may be operable to execute computer instructions that are stored in a computer-readable medium, for example, the memory 308. The processor 302 may be a central processing unit (CPU). While only one processor 302 is illustrated, the mobile device 300 may include multiple processors. The network interface 304 may comprise suitable logic, circuitry, interfaces, and/or code that may be operable to allow the mobile device 300 to transmit and receive data in a network, e.g., the Internet or a cellular network. The network interface 304 may include one or more network interface cards (NICs). The NFC radio 306 may comprise suitable logic, circuitry, interfaces, and/or code that may be operable to transmit or receive data via near field communication technology. The memory 308 may comprise suitable logic, circuitry, interfaces, and/or code that may be operable to store data and/or instructions. As illustrated, the memory 308 may include a locker-opening module 310, a password 312, a confirmation message 314, and an email client module 316.

The mobile device 300 may use the network interface 304 to communicate with the management server 110 or the mail server 120. The mobile device 300 may use the NFC radio 306 to communicate with the locker computer 150A or 150B.

In either the passive locker system 100A or the active locker system 100B, the locker-opening module 310 may be configured to receive, from the management server 110, the password 312 for accessing a locker. The locker may meet a set of requirements (e.g., the locker contains a package for the user of the mobile device, or the user of the mobile device is to place a package into a locker meeting certain geographic location requirements, dimensions requirements, refrigeration requirements, etc.). The locker-opening module 310 may also be configured to transmit, to a locker computer 150A or 150B the password 312 for facilitating unlocking the locker.

In the passive locker system 100A aspect of the subject technology, the locker-opening module 310 may also be configured to receive, from the passive locker computer 150A, the confirmation message 314 indicating that the locker has been unlocked. The locker-opening module 310 may also be configured to transmit, to the management server 110, the confirmation message 314 indicating the locker has been unlocked in response to receiving the confirmation message 314 from the passive locker computer 150A.

The password 312 may be a password which, when transmitted to the locker computer 150A or 150B, causes the locker computer 150A or 150B to facilitate unlocking a locker so that a package can be placed in the locker or removed from the locker. In example aspects, the password 312 may be a public key and a private key corresponding to the public key is stored on the locker computer 150A or 150B.

The confirmation message 314 may be received from the locker computer 150A or 150B. In the passive locker system 100A aspect of the subject technology, the mobile device 300 may transmit the confirmation message to the management server 110. The confirmation message 314 may include a confirmation that a single locker has been unlocked. Alternatively, the confirmation message 314 may include a confirmation that multiple lockers in a geographic location associated with the locker computer 150A have been unlocked during a specified time period. For example, the confirmation message 314 may list all of the lockers that have been unlocked in a particular locker room during the last week, as well as the times when the lockers were unlocked.

The email client module 316 may be configured to allow the mobile device 300 to receive and transmit electronic messages via the mail server 120. For example, the email client module 316 may receive an email message indicating a geographic location or an identity of a locker in which the user of the mobile device 300 is to place a package or in which a package has been left for the user of the mobile device 300 to retrieve.

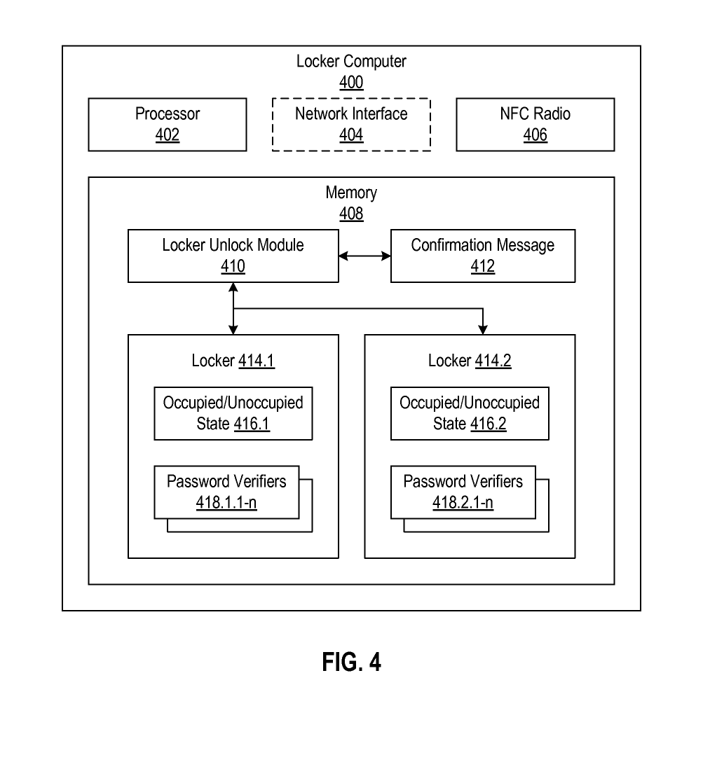

FIG. 4 illustrates an example of a locker computer 400 for a secure locker configured to be accessed via a mobile device. The locker computer 400 may correspond to the passive locker computer 150A or the active locker computer 150B.

As shown, the locker computer 400 may include a processor 402, a near field communication (NFC) radio 406, and a memory 408. The locker computer 400 may also include a network interface 404. The processor 402 may comprise suitable logic, circuitry, interfaces, and/or code that may be operable to execute computer instructions that are stored in a computer-readable medium, for example, the memory 408. The processor 402 may be a central processing unit (CPU). While only one processor 402 is illustrated, the mobile device 400 may include multiple processors. The network interface 404 may comprise suitable logic, circuitry, interfaces, and/or code that may be operable to allow the mobile device 400 to transmit and receive data in a network, e.g., the Internet or a cellular network. The network interface 404 may include one or more network interface cards (NICs). The NFC radio 406 may comprise suitable logic, circuitry, interfaces, and/or code that may be operable to transmit or receive data via near field communication technology. The memory 408 may comprise suitable logic, circuitry, interfaces, and/or code that may be operable to store data and/or instructions. As illustrated, the memory 408 may include a locker unlock module 410, a confirmation message 412, and data structures representing one or more lockers 414.

As illustrated in FIG. 4, the locker computer 400 may also include a network interface 404. In one example, the passive locker computer 150A may not include a network interface 404, while the active locker computer 150B may include a network interface. The active locker computer 150B may use the network interface 304 to communicate with the management server 110. Either the passive locker computer 150A or the active locker computer 150B may use the NFC radio 306 to communicate with the mobile device 130A, 140A, 130B, 140B or 300.

In either the passive locker computer 150A or the active locker computer 150B aspect of the subject technology, the locker unlock module 410 may be configured to receive, from the mobile device 300, a request to unlock a locker. The request may include a password. The locker unlock module 410 may be configured to verify the password. The locker unlock module 410 may be configured to facilitate unlocking the locker in response to verifying the password.

In the active locker computer 150B aspect of the subject technology, the locker unlock module 410 may also be configured to receive an indication that the locker has been closed. The locker unlock module 410 may also update a local data structure 414 indicating whether the locker is occupied based on the indication that the locker has been unlocked and closed. The locker unlock module 410 may also transmit, to the management server 110, one or more messages indicating that the locker has been unlocked and closed. The one or more messages may be for updating a data structure 212 on the management server 110 that indicates whether the locker is occupied.

The confirmation message 412 may be transmitted to the mobile device 300 or, in the active locker system 100B, to the management server 110. The confirmation message 412 may include a confirmation that a single locker has been unlocked. Alternatively, the confirmation message 412 may include a confirmation that multiple lockers in a geographic location associated with the locker computer 400 have been unlocked during a specified time period. For example, the confirmation message 412 may list all of the lockers that have been unlocked in a particular locker room during the last week, as well as the times when the lockers were unlocked.

The confirmation messages 210, 314, and 412, stored on the management server 110, the mobile device 300, or the locker computer 400, respectively, may include similar information or the confirmation messages may be copies or modified versions of one another.

The data structure representing a locker 414.1 may correspond to a locker associated with the locker computer 400. The data structure representing the locker 414.1 may include an indication of an occupied/unoccupied state 416.1 of the locker (i.e., whether the locker 414.1 is occupied or unoccupied). In example aspects, the occupied/unoccupied state 416.1 may be represented as a Boolean value (True or False) or as a single-bit value (0 or 1).

The data structure representing the locker 414.1 may also include a set or an ordered sequence of password verifiers 418.1.1-n for the locker 414.1. The set or ordered sequence of password verifiers 414.1.1-n may include multiple password verifiers (e.g., 10,000 password verifiers) that are cycled through by the locker computer 400. (E.g., the first time the locker 414.1 is accessed the first password verifier 418.1.1 in the ordered sequence is used, the second time the locker 414.1 is accessed, the second password verifier 418.1.2 in the ordered sequence is used, etc.) In the passive locker system 100A aspect of the subject technology, the ordered sequence of password verifiers 418.1.1-n may be stored on the locker computer 400, so that the locker computer does not need to receive the password verifiers 418.1.1-n via a network. In the active locker system 100B aspect of the subject technology, the locker computer 400 may receive the password verifiers 418.1.1-n via the network interface 404. In the active locker system 100B, the locker computer 400 may receive a single password verifier 418.1.k at a time, or an ordered sequence of password verifiers 418.1.1-n in a single transmission.

Other data structures representing lockers 414.2 may include data similar to the data structure representing the locker 414.1. Furthermore, while data structures representing two lockers 414.1-2 are illustrated in FIG. 4, the subject technology may be implemented with any number of data structures representing of lockers 414 stored on the locker computer 400. For example, the locker computer 400 may store data structures representing one locker, ten lockers, 100 lockers, or 1000 lockers. The lockers 414 may correspond to lockers proximate to the locker computer 400 (e.g., lockers in the same locker room or the same building as the locker computer 400). The lockers 414 represented on the locker computer 400 may correspond to a subset of the lockers 212 represented on the management server 110.

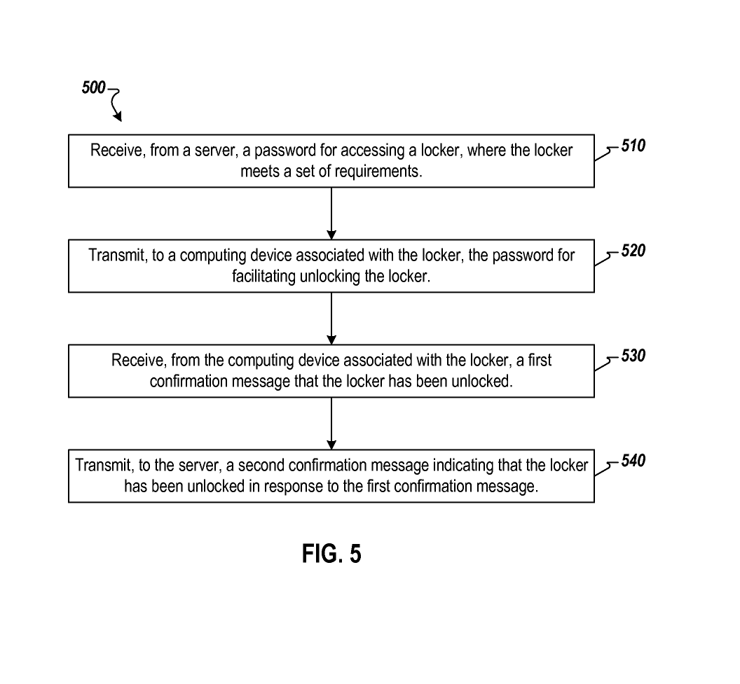

FIG. 5 illustrates an example process 500 by which a mobile device may access a secure locker in a passive locker system.

The process 500 begins at step 510, where a mobile device (e.g., mobile device 130A or 140A passive locker system 100A) may receive, from a server (e.g., management server 110) a password for accessing a locker. The mobile device may also receive, from the server, an indication of the locker (e.g., the street address and locker number of the locker). Alternatively, the user of the mobile device may learn which locker was assigned to him/her via an electronic message (e.g., an email message) received on a computing device different from the mobile device (e.g., a desktop computer), via a telephone call, or via a letter transmitted through postal mail.

The locker may meet a set of requirements. For example, if the mobile device is an end-recipient mobile device, the locker may contain a package for the end-recipient. The end-recipient may have an account (e.g., with a delivery service that provides the lockers) that corresponds to the mobile device. For example, the end-recipient may have registered for the delivery service and provided his/her mobile device information with his/her registration. If the mobile device is a courier mobile device, the locker may meet a requirement that the locker is unoccupied. The locker may also meet the geographic location requirements for the delivery of a package and may meet size, dimensions, refrigeration, or identity verification (e.g., electronic identity verification or identity verification by a human operator) requirements for the delivery of the package. The requirements may be specified by the end-recipient or by the shipper. For example, the shipper may specify the size and dimensions requirements for the locker, while the end-recipient may specify the geographic location requirements for the locker. The set of requirements may also include a requirement that a locker does not contain two different packages for two different end-recipients simultaneously, and that an unoccupied locker that is assigned to a courier for placing a package has not been assigned to any other courier for placing any other packages (i.e., two couriers cannot place their packages into the same locker).

In one aspect, a computing device associated with a locker may be configured to verify the identity of the user. The identity verification may be based on the password, as the password may be provided, by the server, to a specific mobile device of a specific user. In addition, identity verification may also be implemented based on one or more of a scan of an identity card, a photograph of a user's face, a scan of the user's fingerprint(s), an electronic identity card stored within the mobile device and transmitted to the computing device associated with the locker. The user's identity may be verified by an electronic identity verification module that resides on the computing device associated with the locker or on another computing device proximate to the locker. In addition, a pharmacist may be present near the locker or the locker may be located within a pharmacy. As a result, requirements for delivery of pharmaceutical products in some jurisdictions (e.g., identity verification requirements or requirements that a pharmacist be present) may be satisfied. However, such requirements may need to be separately reviewed on a jurisdiction-by-jurisdiction basis. Furthermore, in one aspect, the user may opt-out of having his/her identity verified as set forth above. In another aspect, the user may affirmatively opt-in to having his/her identity verified.

The password may be a onetime password. As used herein, the phrase “onetime password” encompasses its plain and ordinary meaning including, but not limited to a password that is valid for only one login session or transaction or a password that may only be used to unlock a locker once. The password may be configured to expire after a threshold time period (e.g., six hours, twelve hours, or one day) passes. After the password expires, the server may transmit a new password to the mobile device and the mobile device may receive a new password from the server.

The password may be a public key. A private key corresponding to the public key may be stored on the computing device associated with the locker. The private key may be used, by the computing device associated with the locker, to verify the password/public key. In one example, the computing device associated with the locker may store an ordered sequence of private keys and a position in the sequence. The server may store an ordered sequence of public keys corresponding to the ordered sequence of private keys and the position in the sequence. The position may be incremented (e.g., increased by 1) on both the server and the computing device associated with the locker each time a public and private key are used. As a result, the computing device associated with the locker may not need to communicate with the server to obtain the private keys.

In an alternative implementation, the password may be time-limited (i.e., valid for only a certain time period, e.g., a time period between 12 PM and 6 PM, Pacific Time, on Mar. 1, 2012). In one example aspect, a time-limited password may include a secret hash function of a generic password value and the secret hash function of a time specification for the time limit (e.g., an expiration time, a start time and an expiration time, or a start time and a length of time). The server may provide the time-limited password to the mobile device, and the mobile device may provide the time-limited password to the locker computer. In verifying the time-limited password, the locker computer may verify (1) that the generic password value is valid, and (2) that the current time is within the time specification for the time-limited password. The secret hash function may be stored on the server and the locker computer and may be difficult to reverse-engineer. The generic password may be a set of bits. The secret hash function of the generic password and the secret hash function of the time specification may be combined into a single number. The combination of the secret hash function of the generic password and the secret hash function of the time specification may be a 128-bit number. As a result, a malicious user (e.g., a user attempting to extend the time during which he/she can access the locker so that he/she can steal goods from the locker) may not be able to modify the time specification stored in association with the generic password on his/her mobile device without also modifying/corrupting the generic password. It may be crucial or desirable that the generic password and the time specification be combined in a one-way hash, rather than the generic password and the time specification being provided separately.

Any known password verification algorithm may be used in conjunction with the subject technology. The password verification may be implemented in conjunction with a hashing algorithm, for example, MD5, SHA-1, or SHA-2. However, the password may be generated on the server and verified on a locker computer that lacks a network connection or another connection with the server.

The mobile device may communicate with the server via a network for long-range communications (e.g., the Internet, a cellular network, or a telephone network). As used herein, the phrase “network for long-range communications” encompasses its plain and ordinary meaning including but not limited to a network within which data may be transmitted over a distance exceeding a first distance threshold (e.g., a distance greater than 1 km, 10 km, 100 km, or 1000 km).

In step 520, the mobile device may transmit, to a computing device associated with the locker (e.g., to the passive locker computer 150A) the password for facilitating unlocking the locker. The mobile device may communicate with the computing device associated with the locker via a short-range radio connection (e.g., a near field communication connection, a Bluetooth® connection, or a WiFi local area network connection). As used herein, the phrase “short-range radio connection” encompasses its plain and ordinary meaning including but not limited to a connection for transmitting data wirelessly over distance below a second distance threshold (e.g., distances below 10 cm, 20 cm, 1 m, 100 m, or 1 km).

In step 530, the mobile device may receive, from the computing device associated with the locker, a first confirmation message that the locker has been unlocked.

In step 540, the mobile device may transmit, to the server, a second confirmation message indicating that the locker has been unlocked in response to the first confirmation message. The second confirmation message may be for updating a data structure, residing on the server, that represents an occupied/unoccupied state of the locker (e.g., data structure 212 in the memory 206 of the management server 110).

In example aspects, a security camera proximate to the locker may also be used to verify whether packages were placed in or received from lockers. Footage from the security camera may be stored, in a memory unit coupled to the security camera via a wire or via a network connection, for a certain time period (e.g., one month, six months, or one year).

The first confirmation message and the second confirmation message may include the same information. In one example, the first confirmation message and/or the second confirmation message includes indications whether multiple lockers in a geographic area associated with the locker (e.g., in the same locker room or the same building as the locker) have been unlocked during a specified time period (e.g., one hour, six hours, one day, or one week before the first confirmation message was generated on the computing device associated with the locker). Each indication that a locker has been unlocked may be coupled with a timestamp indicating the time when the locker was unlocked. After step 540, the process 500 ends.

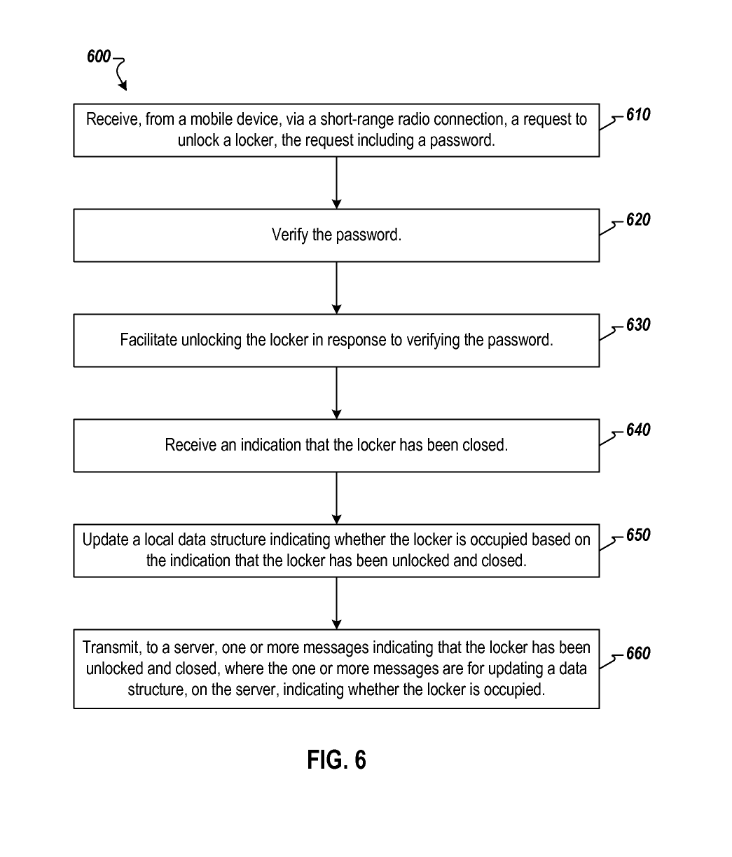

FIG. 6 illustrates an example process 600 by which a locker computer may allow access to a mobile device an active locker system.

In step 610, the active locker computer (e.g., active locker computer 150B) may receive, from a mobile device (e.g., end-recipient mobile device 130B or courier mobile device 140B), via a short-range radio connection (e.g., a NFC connection) a request to unlock a locker. The request may include a password.

The password may be transmitted from a server (e.g., management server 110) to the mobile device and from the mobile device to the active locker computer. The password may be a onetime password. The password may be configured to expire after a threshold time period (e.g., six hours, twelve hours, or one day) passes. After the password expires, the server may transmit a new password to the mobile device.

In step 620, the active locker computer may verify the password. In one example, the password is a public key, and the active locker computer may verify the password based on a specific private key stored in a local memory of the active locker computer. The memory of the active locker computer may include an ordered sequence of private keys, and the specific private key may correspond to a private key in a predetermined position of the ordered sequence of private keys. Similarly, the memory of the server may include an ordered sequence of public keys, and a public key in the predetermined position may be transmitted to the mobile device. As a result, the mobile device may transmit a password/public key to the active locker computer that corresponds to a private specific private key stored on the active locker computer.

In example aspects, the request to unlock the locker, received from the mobile device, may also include an indication of the identity of the user. The password may be an indication of the identity of the user, as the password may be provided, by the server, to a specific mobile device of a specific user. In addition, a user's identity may be verified electronically based on one or more of an electronic identity card, a scan of a physical identity card, a photograph of the user's face, or a scan of the user's fingerprint(s). A computing device (e.g., the active locker computer or another computer) may compare the user's photograph with his/her identity card (scanned or stored within the computing device) to verify his/her identity. The locker may be unlocked in response to verifying the identity of the user. In addition, a pharmacist may be present near the locker or the locker may be located within a pharmacy. As a result, requirements for delivery of pharmaceutical products in some jurisdictions (e.g., identity verification requirements or requirements that a pharmacist be present) may be satisfied. However, such requirements may need to be separately reviewed on a jurisdiction-by-jurisdiction basis. Furthermore, in one aspect, the user may opt-out of having his/her identity verified or his/her information stored within the computing device as set forth above. In another aspect, the user may affirmatively opt-in to having his/her identity verified or his/her information stored within the computing device.

In step 630, the active locker computer may facilitate unlocking the locker in response to verifying the password.

In step 640, the active locker computer may receive an indication that the locker has been closed. The indication that the locker has been closed may come from a sensor on the locker.

In step 650, the active locker computer may update a local data structure (e.g., data structure 414 in the memory 408 of the locker computer 400) indicating whether the locker is occupied based on the indication that the locker has been unlocked and closed.

In step 660, the active locker computer may transmit, to the server (e.g., management server 110), via a network for long-range communications (e.g., a cellular network), one or more messages indicating that the locker has been unlocked and closed. The one or more messages are for updating a data structure (e.g., data structure 212 in the memory 206 of the management server 110), on the server, indicating whether the locker is occupied. The one or more messages may include a copy of the local data structure indicating whether the locker is occupied based on the indication that the locker has been unlocked and closed. After step 660, the process 600 ends.

FIG. 7 illustrates an example process 700 by which a server may allow a mobile device to access a secure locker.

The process 700 begins at step 710, where the server (e.g., management server 110) may determine a specific locker. The specific locker may meet a set of requirements. For example, the specific locker may contain a package for a specific end-recipient who is a user of a mobile device. Alternatively, the specific locker may be a locker in which a package for an end-recipient is to be placed. The set of requirements may include a requirement that the specific locker is unoccupied and that the specific locker has not been assigned to another courier for placement of another package. The other package may be for another recipient. The set of requirements may also include requirements that the locker is located in a geographic location selected by the end-recipients, that the locker is accessible at a time selected by the recipient, or that the locker meets size, dimensions, or refrigeration requirements for holding the package. The size, dimensions, or refrigeration requirements for holding the package may be transmitted to the server from a client computing device associated with the shipper. In one example, the set of requirements may include a requirement that the identity of the end-recipient be verified before the end-recipient is permitted to access the locker.

In one example, the process 700 may be initiated by the server receiving a request (e.g., from a shipper) for a locker. The request may include the set of requirements or a portion of the requirements within the set. In one example, the server may obtain a portion of the set of requirements from the shipper and another portion of the set of requirements from the end-recipient.

In step 720, the server may provide an indication of the specific locker to a messaging system (e.g., mail server 120). The messaging system may send a message to a user of the mobile device (e.g., an email message to an email address provided by the user of the mobile device, a telephone call to a telephone number, a postal letter, or a text message to the mobile device) informing the user of the mobile device that he/she should visit the specific locker (e.g., to retrieve a package or to leave a package for an end-recipient).

In step 730, the server may provide a password for unlocking the specific locker to the mobile device (e.g., mobile device 130A, 140A, 130B, or 140B). In one example, the server may store an ordered sequence of passwords and a position in the ordered sequence and provide the password at the position in the ordered sequence to the mobile device. A locker computer (e.g., locker computer 150A or 150B) may store a corresponding ordered sequence of password verifiers and a position in the ordered sequence. The server may increment the position in the ordered sequence upon providing the password, and the locker computer may increment the password verifier upon receiving the password from a mobile device. Thus, in one example, the server does not provide password verification data to the locker computer.

In example aspects, the messaging system and the mobile device are a single device, i.e., the server may provide the indication of the specific locker (e.g., an electronic message identifying the geographic location of the specific locker and the locker number of the specific locker, if applicable) and the password for unlocking the locker to the same device. Alternatively, the messaging system and the mobile device may be different devices. For example, a user of a mobile device may receive the electronic message identifying the specific locker in an email address for which he/she does not receive messages on the mobile device.

In step 740, the server may receive a confirmation message that the specific locker has been unlocked. The confirmation message may be received on the server via a network for long-range communications. The confirmation message may be received from the mobile device (e.g., in passive locker system 100A) or from the locker computer (e.g., in active locker system 100B). The confirmation message may include an indication that a specific locker has been unlocked. Alternatively, the confirmation message may include indications that multiple lockers have been unlocked within a threshold time period (e.g., 6 hours, 24 hours, or one week) before the confirmation message was generated and timestamps corresponding to the times when the multiple lockers were unlocked.

In step 750, the server may update a data structure (e.g., data structure 212) indicating whether the specific locker is occupied in response to receiving the confirmation message. If the confirmation message includes indications that multiple lockers have been unlocked, the server may also update the data structure for the multiple lockers according to the confirmation message. After step 750, the process 700 ends.

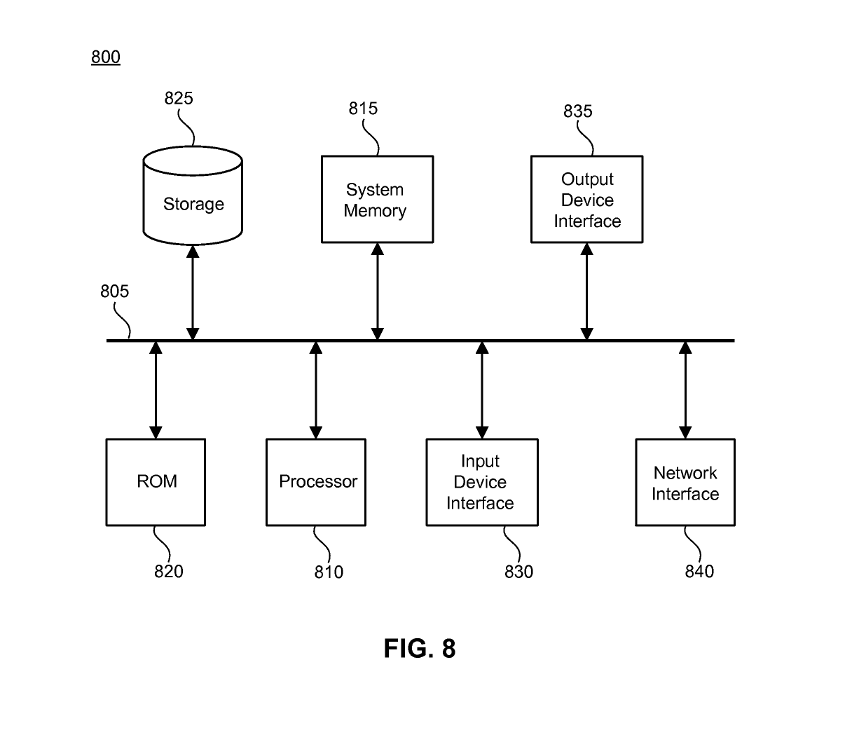

FIG. 8 conceptually illustrates an electronic system 800 with which some implementations of the subject technology are implemented. For example, one or more of the management server 110, the mail server 120, the end-recipient mobile device 130A or 130B, the courier mobile device 140A or 140B, the passive locker computer 150A, the active locker computer 150B, the mobile device 300, or the locker computer 400 may be implemented using the arrangement of the electronic system 800. The electronic system 800 may be a computer (e.g., a mobile phone, PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, an input device interface 830, an output device interface 835, and a network interface 840.

The bus 805 may collectively represent all system, peripheral, and chipset buses that communicatively connect the numerous internal devices of the electronic system 800. For instance, the bus 805 may communicatively connect the processing unit(s) 810 with the read-only memory 820, the system memory 815, and the permanent storage device 825.

From these various memory units, the processing unit(s) 810 may retrieve instructions to execute and data to process in order to execute the processes of the subject technology. The processing unit(s) may be a single processor or a multi-core processor in different implementations.

The read-only-memory (ROM) 820 may store static data and instructions that are needed by the processing unit(s) 810 and other modules of the electronic system. The permanent storage device 825, on the other hand, may be a read-and-write memory device. This device may be a non-volatile memory unit that stores instructions and data even when the electronic system 800 is off. Some implementations of the subject technology use a mass-storage device (for example, a magnetic or optical disk and its corresponding disk drive) as the permanent storage device 825.

Other implementations may use a removable storage device (for example a floppy disk, flash drive, and its corresponding disk drive) as the permanent storage device 825. Like the permanent storage device 825, the system memory 815 may be a read-and-write memory device. However, unlike storage device 825, the system memory 815 may be a volatile read-and-write memory, such a random access memory. The system memory 815 may store some of the instructions and data that the processor needs at runtime. In some implementations, the processes of the subject technology may be stored in the system memory 815, the permanent storage device 825, and/or the read-only memory 820. For example, the various memory units may include instructions for accessing a secure locker via a mobile device in accordance with some implementations. From these various memory units, the processing unit(s) 810 may retrieve instructions to execute and data to process in order to execute the processes of some implementations.

The bus 805 may also connect to the input and output device interfaces 830 and 835. The input device interface 830 may enable the user to communicate information and select commands to the electronic system. Input devices used with input device interface 830 may include, for example, alphanumeric keyboards and pointing devices (also called “cursor control devices”). Output device interfaces 835 may enable, for example, the display of images generated by the electronic system 800. Output devices used with output device interface 835 may include, for example, printers and display devices, for example, cathode ray tubes (CRT) or liquid crystal displays (LCD). Some implementations may include devices for example a touchscreen that functions as both input and output devices.

Finally, as shown in FIG. 8, bus 805 may also couple electronic system 800 to a network (not shown) through a network interface 840. In this manner, the electronic system 800 may be a part of a network of computers (for example a local area network (“LAN”), a wide area network (“WAN”), or an Intranet, or a network of networks, for example the Internet. Any or all components of electronic system 800 may be used in conjunction with the subject technology.

The above-described features and applications may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” may include firmware residing in read-only memory or applications stored in magnetic storage or flash storage, for example, a solid-state drive, which can be read into memory for processing by a processor. Also, in some implementations, multiple software technologies may be implemented as sub-parts of a larger program while remaining distinct software technologies. In some implementations, multiple software technologies may also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) may be written in any form of programming language, including compiled or interpreted languages, declarative or procedural languages, and it may be deployed in any form, including as a stand alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

These functions described above may be implemented in digital electronic circuitry, in computer software, firmware or hardware. The techniques may be implemented using one or more computer program products. Programmable processors and computers can be included in or packaged as mobile devices. The processes and logic flows may be performed by one or more programmable processors and by one or more programmable logic circuitry. General and special purpose computing devices and storage devices may be interconnected through communication networks.

Some implementations may include electronic components, for example microprocessors, storage and memory that store computer program instructions in a machine-readable or computer-readable medium (alternatively referred to as computer-readable storage media, machine-readable media, or machine-readable storage media). Some examples of such computer-readable media may include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code may include machine code, for example is produced by a compiler, and files including higher-level code that are executed by a computer, an electronic component, or a microprocessor using an interpreter.

While the above discussion primarily refers to microprocessor or multi-core processors that execute software, some implementations may be performed by one or more integrated circuits, for example application specific integrated circuits (ASICs) or field programmable gate arrays (FPGAs). In some implementations, such integrated circuits may execute instructions that are stored on the circuit itself

As used in this specification and any claims of this application, the terms “computer”, “server”, “processor”, and “memory” may all refer to electronic or other technological devices. These terms may exclude people or groups of people. For the purposes of the specification, the terms display or displaying means displaying on an electronic device. As used in this specification and any claims of this application, the terms “computer readable medium” and “computer readable media” may be entirely restricted to tangible, physical objects that store information in a form that is readable by a computer. These terms may exclude any wireless signals, wired download signals, and any other ephemeral signals.

To provide for interaction with a user, implementations of the present disclosure may be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices may be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer may interact with a user by sending documents to and receiving documents from a device that is used by the user; for example, by sending web pages to a web browser on a user's client device in response to requests received from the web browser.

The present disclosure may be implemented in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system may be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some aspects of the present disclosure, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A method, implemented on a mobile computing device, for accessing a locker, the method comprising:
receiving, from a server, a password for accessing a locker;
transmitting, to a computing device associated with the locker, the password for accessing the locker, wherein the transmitting provides for unlocking the locker;
receiving, from the computing device associated with the locker, a first confirmation message that the locker has been unlocked; and
transmitting, to the server, a second confirmation message indicating that the locker has been unlocked, in response to receiving the first confirmation message.

2. The method of claim 1, further comprising receiving, from the server, an indication of the locker.

3. The method of claim 1, wherein the password comprises a public key, and wherein a private key corresponding to the public key is stored on the computing device associated with the locker.

4. The method of claim 3, wherein the computing device associated with the locker stores an ordered sequence of private keys, and wherein the server stores an ordered sequence of public keys corresponding to the ordered sequence of private keys.

5. The method of claim 1, wherein transmitting the password to the computing device associated with the locker for facilitating unlocking the locker comprises transmitting the password to the computing device associated with the locker via a short-range radio connection.

6. The method of claim 1, wherein the locker meets a set of requirements.

7. The method of claim 6, wherein the set of requirements comprises one or more of delivery geographic location requirements, locker size requirements, locker refrigeration requirements, or identity verification requirements.

8. The method of claim 1, wherein the set of requirements comprises a requirement that the locker is unoccupied and the mobile computing device is associated with a courier account or wherein the set of requirements comprise a requirement that the locker is occupied with a package and the package is associated with an end-recipient account corresponding to the mobile computing device.

9. The method of claim 1, wherein the first confirmation message comprises indications whether a plurality of lockers in a geographic area associated with the locker have been unlocked during a specified time period, and wherein the second confirmation message comprises the indications whether the plurality of lockers in a geographic area associated with the locker have been unlocked during the specified time period.

10. The method of claim 1, wherein the specified time period comprises a time period between a preset time before a time of transmission of the first confirmation message from the computing device associated with the locker and the time of transmission of the first confirmation message.

11. A computer-readable medium for accessing a locker, the computer-readable medium comprising instructions which, when executed by a computer, cause the computer to:
receive a password for accessing a locker;
transmit, via a short-range radio connection, the password for facilitating unlocking the locker;
receive, via the short-range radio connection, a first confirmation message that the locker has been unlocked; and
transmit a second confirmation message indicating that the locker has been unlocked in response to the first confirmation message.

12. A mobile device for accessing a locker, the mobile device comprising:
a radio for short-range communication;
a radio for long-range communication;
one or more processors; and
a memory comprising instructions which, when executed by the one or more processors, cause the one or more processors to:
receive, from a server, via the radio for long-range communication, a password for accessing a locker;
transmit, to a computing device associated with the locker, via the radio for short-range communication, the password for facilitating unlocking the locker;
receive, from the computing device associated with the locker, via the radio for short-range communication, a first confirmation message that the locker has been unlocked; and
transmit, to the server, via the radio for long-range communication, a second confirmation message indicating that the locker has been unlocked in response to the first confirmation message.

13. A computer-implemented method for managing a locker, the method comprising:
receiving, from a mobile device, via a short-range radio connection, a request to unlock a locker, the request comprising a password;
verifying the password;
providing for unlocking the locker in response to verifying the password;
receiving an indication that the locker has been closed; and
transmitting, to a server, one or more messages indicating that the locker has been unlocked and closed, wherein the one or more messages is for updating a data structure, on the server, indicating whether the locker is occupied.

14. The method of claim 13, wherein the request to unlock the locker further comprises an indication of an identity of a user, the method further comprising:
verifying the identity of the user based on the indication of the identity of the user, wherein the providing for unlocking the locker is in response to verifying the identity of the user.

15. A computer-readable medium for managing a locker, the computer-readable medium comprising instructions which, when executed by a computer, cause the computer to:
receive, from a mobile device, via a short-range radio connection, a request to unlock a locker, the request comprising a password;
verify the password;
provide for unlocking the locker in response to verifying the password;
update a local data structure indicating whether the locker is occupied based on the indication that the locker has been unlocked; and
transmit, to a server, one or more messages indicating that the locker has been unlocked, wherein the one or more messages is for updating a data structure, on the server, indicating whether the locker is occupied.

16. The computer-readable medium of claim 15, wherein the one or more messages indicating that the locker has been unlocked comprise the local data structure indicating whether the locker is occupied.

17. The computer-readable medium of claim 15, wherein the instructions to transmit, to the server, the one or more messages indicating that the locker has been unlocked comprises instructions which, when executed by the computer, cause the computer to:
transmit, to the server, the one or more messages via a long-range connection.

18. The computer-readable medium of claim 15, wherein the request to unlock the locker further comprises an indication of an identity of a user, the computer-readable medium further comprising instructions which, when executed by the computer, cause the computer to:
verify the identity of the user based on the indication of the identity of the user,
wherein the instructions to provide for unlocking the locker comprise instructions which, when executed by the computer, cause the computer to provide for unlocking the locker in response to verifying the identity of the user.

19. A computing device for managing a locker, the computing device comprising:
a near field communication radio;
a network interface;
one or more processors; and
a memory comprising instructions which, when executed by the one or more processors, cause the one or more processors to:
receive, from a mobile device, via the near field communication radio, a request to unlock a locker, the request comprising a password;
verify the password;
provide for unlocking the locker in response to verifying the password; and
transmit, via the network interface, to a server, one or more messages indicating that the locker has been unlocked, wherein the one or more messages is for updating a data structure, on the server, indicating whether the locker is occupied.

20. A computer-readable medium for managing a set of lockers, the computer-readable comprising instructions which, when implemented by one or more computers, cause the one or more computers to:
receive a set of requirements for a locker;
determine a specific locker which meets the set of requirements;
provide an indication of the specific locker to a messaging system;
provide a password for unlocking the specific locker to a mobile device;
receive a confirmation message indicating that the specific locker has been unlocked; and
update a data structure indicating whether the specific locker is occupied in response to receiving the confirmation message.
